(19) United States
(12) Patent Application Publication
(10) Pub. No.: US 2004/0153558 A1
(43) Pub. Date: Aug. 5, 2004

(54) System and method for providing java based high availability clustering framework

(76) Inventors: Mesut Gunduc, Seattle, WA (US); Tena Heller, Liberty Corner, NJ (US)

Correspondence Address: FLIESLER MEYER, LLP, FOUR EMBARCADERO CENTER, SUITE 400, SAN FRANCISCO, CA, 94111, US

(21) Appl. No.: 10/693,137

(22) Filed: Oct. 24, 2003

Related U.S. Application Data
(60) Provisional application No. 60/422,528, filed on Oct. 31, 2002.

(51) Int. Cl. G06F 15/16

(52) U.S. Cl. 709/229

(57) ABSTRACT

A Java-based system or framework for high availability Java-based clustering that includes a cluster server having a variety of resources and interfaces, including a cluster application program interface, group services, failure management, resource management, membership services, communications, a heartbeat interface, cluster database and management, a JNDI interface, and a resource API interface. The resource API allows the cluster server to talk to a variety of plug-ins, which in turn interface with other resources and application servers and support high availability framework for those resources and servers.

### CLAIM OF PRIORITY

This application claims the benefit of U.S. Provisional Application No. 60/422,528, filed Oct. 31, 2002.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is related generally to systems and methods for high availability of computer systems, and particularly to a system for providing high availability clustering.

### BACKGROUND

In the field of enterprise level software computing the consistent availability of resources, services, and applications are of paramount importance. Banks, financial institutions, and large manufacturing organizations, rely on the fact that their computer systems will operate on a 24 hour by 7 days per week basis. The ability to provide such rugged computer systems falls within the general field of high availability (HA) computing. The concept of high availability has always been one of the key requirements in providing a mission-critical application environment. The explosive growth of e-commerce applications, and increasing demands of sophisticated users, make this requirement ever more important in today's society. As such, more and more application system vendors (those who provide the systems used to run enterprise-level applications) are including a high availability component in their product. The presence or absence of a high availability component can be a very important differentiation factor when comparing otherwise similar application vendor products.

Some application and server system vendors such as Microsoft and Veritas, have already demonstrated the feasability of building software only HA frameworks or systems. Such products include Microsoft's Cluster Server (formerly called Wolf Pack) and Tandem's Himalaya Server, (now owned by Compaq/Hewlett-Packard. A typical HA framework is shown in FIG. 1. As can be seen in FIG. 1, the system allows a plurality of network nodes 102, each maintained by a cluster server CS 104, to continuously maintain updated application information within the cluster. Each node includes their own node disk space 108 and has access to a shared disk space 112 within which the node saves continuously updated HA information. The individual nodes provide a plurality of applications 106. To the client 110 accessing this cluster farm, the individual clusters appear as a single entity. If one of the nodes were to fail, another node would take over almost instantaneously. If this switchover is performed in a short enough amount of time, then the client will not even notice the node has failed.

Most third-party HA solutions, such as that shown in FIG. 1, share a lot of common features in terms of functionality and limitations. These include:

Typically the use of a cluster node 102 (a physical computer or nodes), together with a network level heartbeat mechanism 114. The heartbeat mechanism is used for detecting membership and failures in the cluster;

Synchronization and coordination mechanisms for communicating global events and updates throughout the cluster;

A framework mechanism that allows applications to register callbacks for booting up and shutting down application specific components, which are then used for failure detection failover and fail back;

A management framework or set of utilities, to allow an administrator to manage the cluster environment, typically via an admin console 120;

Some mechanism for providing resource interdependency, and an orderly failover or fail back of configured resources;

Platform-specific features, such as for example the Sun cluster on the Sun platform; and,

A shared set of resources for allowing cluster quorum. This quorum may for example be a memory device, or a fixed disk. Typically the fixed disk is on a shared network server, and uses some form of redundancy, for example, Redundant Array of Inexpensive Disks (RAID).

However, one of the major problems with currently available cluster offerings is the need to integrate the cluster framework with its applications by providing a set of application-specific callbacks. These application-specific callbacks are needed to allow adequate control and monitoring of the software applications running on the cluster. Callbacks that are typically used include application scripts, Dynamically Loadable Libraries (DLL's), and regular compiled/executable code. The actual callback implementation used depends on the cluster product itself.

FIG. 2 illustrates an integration point between an application and a cluster for a typical cluster product, (for example the WebLogic Server product from BEA Systems, Inc). Other server products may use similar callback mechanisms. As can be seen in FIG. 2, with a standard WebLogic Server application 122, the application-specific callback between the cluster server 104 and the application 122 is usually a WebLogic Server callback component 134. So, in the example of a Tuxedo application the callback would likely be a Tuxedo callback component 136. Additional types of application server and applications require their own specific callback 138. The cluster server talks to the various callbacks via a callback interface 130 which typically comprises functions such as online, or offline of an application resource, or a check mechanism to see if an application resource is still alive.

The problem with this and with other traditional approaches to clustering, is that a failover or failback operation is not much more than a shutting down of the resources on the current host node, and a subsequent restart or a reboot of those same resources on an alternate node. In the case of database applications, the database connections would need to be recycled as needed. The core logic within such a system is typically confined to a single multi-threaded process, generically referred to as the cluster server. One cluster server typically operates per cluster member node, and communicates with other cluster server processes on other active nodes within that cluster. The cluster server is also responsible for calling application-type-specific callback functions depending on the global events occurring within that cluster, for example a cluster node failure, a node leaving the cluster, a planned failover request, or a resource online/offline.

Beyond this clustering model some attempts have been made to provide clustering features in the application server environment. One example of this is provided in current versions of the WebLogic Server clustering product and in clustering products provided by other vendors. However the current methods of providing clustering are not strictly speaking HA implementations. These current methods are geared more towards service replication and load balancing. In particular, they attempt to address the high availability problem solely in the context of a single application server, for example WebLogic, and this is at best a partial solution to the high availability problem. Current server architectures are not flexible enough to provide availability in an application-environment-wide scenario. In addition, interdependency and ordering relationships among HA resources are important elements of an HA solution, and current offerings do not address this requirement.

A highly available application environment comprises not only application servers, but also other resources that are needed for successful service delivery, for example internet protocol addresses, database servers, disks, and other application and transaction services. Each component within this application environment also has interdependency and ordering relationships that must be taken into account. In order to support this, what is needed is a mechanism that can take all of these demands and factors into account, while moving away from a hardware-specific or vendor-centric offering, to a more globally orientated HA framework. Such a framework should be able to work with a majority, if not all, of the application types on the market, and should be flexible enough to adapt to future needs as they arise.

### SUMMARY

High Availability (HA) has always been one of the key requirements in mission-critical application environments. With the explosive growth of e-commerce, it is even more critical now than ever before. This feature can also be a very important differentiating feature between competing products if it is provided and marketed effectively and timely.

A clustering solution for high availability can thus be seen as a key building block or at least a useful extension to an application server. A highly available application environment comprises not only application servers, but also other resources that are needed for the successful service delivery, e.g. Internet Protocol (IP) addresses, database (DB) servers, disks, and other servers. The components of an application environment also have interdependencies, and ordered relationships. A well designed HA framework must take these factors into account.

Furthermore, in the business computing industry, Java Virtual Machine (JVM) technology is becoming the standard platform of e-commerce. For the first time, it is now possible to create a cluster consisting of heterogeneous nodes, computers from different vendors, all sharing a common JVM platform. This ability, combined with the “Write-Once, Run-Anywhere” aspect of Java technology, makes it desirable to build a Java-based framework that offers far more superior benefits than the traditional non-Java HA framework offerings from other vendors. Traditional solutions usually only work on the vendors' platform and no other platform, and are somewhat tied to the underlying hardware and OS platform, so they are very much vendor-centric.

Generally described, an embodiment of the invention comprises a system or a framework for high availability clustering that is primarily Java-based. The High Availability Framework (HAFW) described herein is intended to be a general purpose clustering framework for high availability in Java space, that can be used to provide a software-only solution in the complex field of high availability. The HAFW supports a very close synergy between the concepts of system/application management and high availability, and may be incorporated into existing application server platforms. This results in a more scalable, slimmer, and more manageable product with powerful abstractions to build upon.

### BRIEF DESCRIPTION OF THE FIGURES

FIG. 1 shows a typical commercially available HA framework.

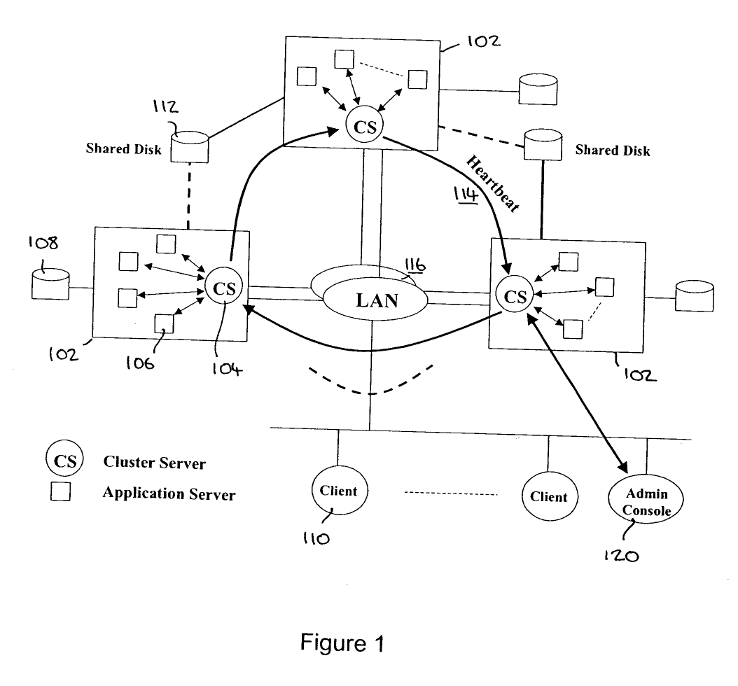

FIG. 2 illustrates an integration point between an application and a cluster for a typical cluster product in this instance WebLogic Server.

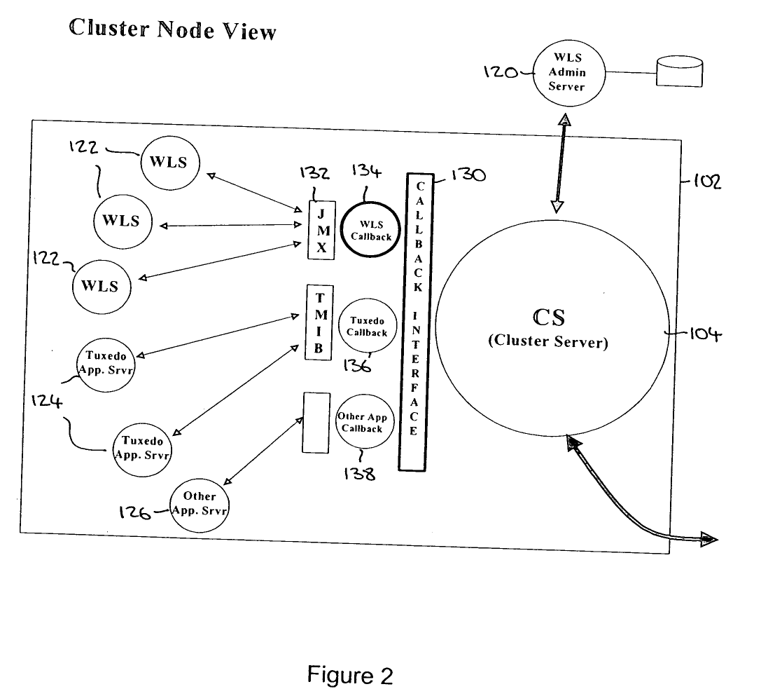

FIG. 3 shows a topological perspective of a system in accordance with an embodiment of the current invention.

FIG. 4 illustrates in closer detail the architecture of a cluster server in accordance with an embodiment of the invention.

FIG. 5 illustrates how a plurality of cluster servers together with the Global Update Protocol are used to provide support for a high availability framework.

FIG. 6 illustrates the flow of heartbeat information as it passes from one cluster server to another in accordance with one embodiment of the invention.

FIG. 7 illustrates the flow of heartbeat information as it passes from one cluster server to another in accordance with one embodiment of the invention.

FIG. 8 illustrates how in accordance with one embodiment of the invention the Global Update Protocol heartbeat information is passed between cluster servers in a parallel rather than in a serial manner.

FIG. 9 illustrates alternate embodiment of the heartbeat sending mechanism wherein the heartbeat is sent using a multicast pattern so that the heartbeat can be sent to any or all of the cluster servers at the same time, and in which case the sender waits for all of the heartbeats to return before proceeding.

FIG. 10 illustrates how the various resource objects are stored within the framework database in accordance with an embodiment of the invention.

FIG. 11 illustrates one implementation of the log file as it is used in the high availability framework.

FIG. 12 illustrates how in accordance with one embodiment of the invention a client application can use an invokation method such as the Remote Method Invokation (RMI) to access a cluster server for administration for or other control purposes.

FIG. 13 depicts the application management architecture of a commonly used version of WLS. In this architecture, WLS instances make up WLS clusters.

FIG. 14 illustrates an alternate embodiment of the invention in which one server instance, such as a WebLogic server instance, in each server cluster acts as an application management agent for that cluster, and also as a bridge between the WLS administration server and the members i.e. the WLS instances of the cluster.

FIG. 15 illustrates a cluster view from the physical computer level, in which a group of interconnected computers each supporting a Java virtual machine are represented.

FIG. 16 illustrates an alternate implantation of the high availability framework based upon the physical implementation shown in FIG. 15.

FIG. 17 depicts the anatomy of a Cluster Server process in accordance with this embodiment.

FIG. 18 illustrates how individual framework subscribers can be grouped together to provide process groups.

### DETAILED DESCRIPTION

A highly available (HA) application environment comprises not only application servers, but also other resources that are needed for the successful service delivery, e.g. Internet Protocol (IP) addresses, database (DB) servers, disks, other servers. The components of an application environment also have interdependency, ordered relationships. A well designed HA framework must take these factors into account.

Furthermore, in the business computing industry, Java Virtual Machine (JVM) technology is becoming the standard of e-commerce. As provided by the invention, it is now possible to create a cluster consisting of heterogeneous nodes, and computers from different vendors, all sharing a common JVM platform. This allows for building a Java-based framework that offers far more superior benefits than the traditional HA framework offerings from other vendors. Traditional hardware vendor-provided solutions usually only work on the vendors' platform and no other platform, and are somewhat tied to the underlying hardware and OS platform, so they are very much vendor-centric.

Generally described, an embodiment of the invention comprises a system or a framework for high availability clustering that is, in accordance with one embodiment, primarily Java-based. The High Availability Framework (HAFW) described herein is intended to be a general purpose clustering framework for high availability in Java space, that can be used to provide a software-only solution in the complex field of high availability. The HAFW supports a very close synergy between the concepts of system administration, application management, and high availability, and may be incorporated into existing application server platforms. This provides a more scalable, slimmer, and more manageable product, with powerful abstractions to build upon.

One of the first steps in deciding on how to provide a high availability framework (HAFW) is to decide on the underlying platform. Java, and particularly the Java Virtual Machine (JVM), is becoming a commonly used platform of e-commerce environments. Using Java it is possible to set up a cluster comprising heterogeneous nodes and computers from different vendors whose only commonality is that they use a JVM. Java's widespread acceptance, combined with its “right once, run anywhere” features, make it a good choice upon which to build a Java based HA framework. To date, little has been done to provide a commercially available framework based on a JVM platform. However, the JVM platform provides superior benefits from traditional HA framework offerings in that it is not vendor-centric and is not tied to any underlying hardware or operating system platform.

Hardware Clusters

Viewed from a topological perspective, a cluster is a group of interconnected stand-alone computers. The cluster is usually configured with a persistent shared store (or database) for quorum. As used in embodiments of the invention, the core of the clustering functionality is built into a multi-threaded process called a Cluster Server, which can be entirely implemented in Java. In the subsequent sections, various embodiments of the system are referred to as HAFW, an acronym for “High Availability FrameWork”.

In HAFW, an application server environment is viewed as a pool of resources of various resource types. A resource is defined to be any logical or physical object that is required for the availability of the service or services which the application environment is providing. Each resource has a resource lifecycle and a resource type associated with it. In object-oriented parlance, the resource type corresponds to a class with a certain behavior, and a set of attributes. So, in accordance with this implementation, resources become the object instances of their respective resource types.

For example, as used in WebLogic Server (WLS), a WLS server instance is a resource of resource type “WLSApplicationServer”. A Tuxedo application instance is a resource of resource type “TuxedoApplicationServer”. By the same analogy, a cluster computer, an IP address, or a disk, are all also resources, each of which belongs to its corresponding resource type. Different resource types usually have different sets of attributes associated with them.

Resources in an enterprise application environment may also have interdependency relationships. For example, a WLS instance may depend on a database (DB) server, which in turn may depend on the data on a disk, or on a Tuxedo application instance having a dependency on an IP address. This interdependency relationship becomes very critical during failover/failback operations or during any resource state change requests.

HAFW also supports the use of a Resource Group. As used herein a resource group allows related resources to be grouped together. In accordance with one embodiment of the invention, a resource is always associated with at least one resource group. A resource group is an object itself and has its own attributes (e.g. an ordered list of cluster members that can be a host for it). The resource group is also an attribute of a resource. When a resource is removed from one resource group and added to another resource group this attribute will correspondingly change. The resource group is thus a unit of the failover/failback process provided by the HAFW, and is also the scope for resource interdependency and ordering. A resource's dependency list (an attribute) can only contain resources within the same resource group.

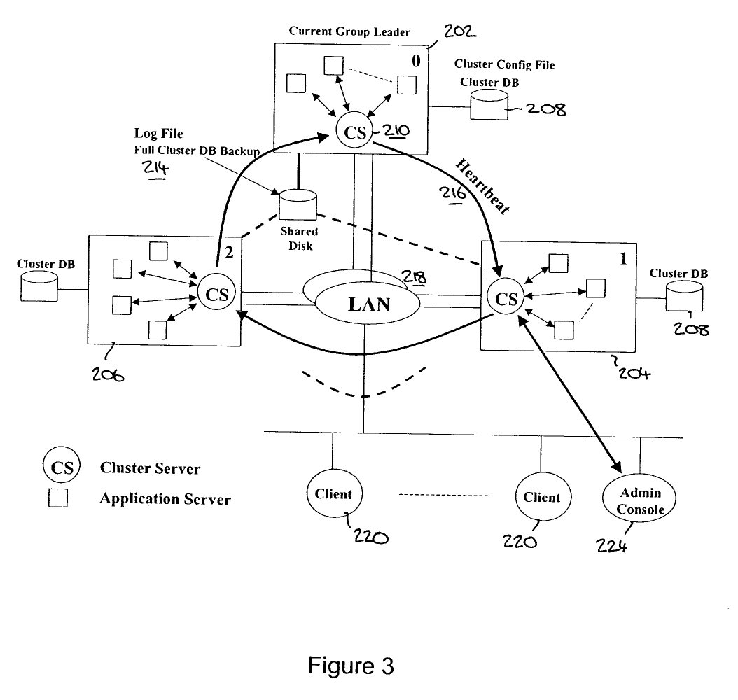

FIG. 3 shows a topological perspective of a system in accordance with an embodiment of the invention. As shown in FIG. 3, a cluster is a group of interconnected, yet otherwise stand-alone, computers or “machines”, in this instance each computer supporting J2EE. The cluster is configured with a persistent shared store for quorum. The core of the clustering functionality is built into a multi-threaded process called a cluster server, that can be entirely implemented in Java. FIG. 3 illustrates one embodiment of the invention as it is used to provide a high availability framework cluster (HAFW), in which a plurality of client or client applications can access the cluster and the resources thereon. In the HAFW, the application server environment is viewed as a pool of resources of various resource types. As described above, the term “resource” refers to any logical or physical object that is required for the availability of the service or services which the application environment provides. FIG. 3 shows how a cluster of machines 202, 204, 206 are used to provide a cluster of shared resources, that are then accessible to or by a plurality of clients 220. Each of the machines 202, 204, 206 include a cluster server 210, and one or more application servers 212. As used herein, the application server may be, for example, a WebLogic server instance, while the cluster server may be another WebLogic server instance that is dedicated to operate as a cluster server. In the cluster environment, each of the individual machines are connected via a local area network (LAN) 218, or via some other form of communication mechanism. One of the machines is dedicated as a current group leader 202, which allows the other machines and associated cluster servers, including machines 204 and 206, to act as members within the cluster. A heartbeat signal 216 is used to relay high-availability information within the cluster. Each machine and associated cluster server also includes its own cluster database 208, together with a cluster configuration file that is maintained by the current group leader. A shared disk or storage space 214 is used to maintain a log file 214 that can also be used to provide cluster database backup. The entire system can be configured at any of the cluster servers using an administrative console application 224.

In the implementation shown in FIG. 3, a server instance can be, for example, a resource of resource type “WLS application server”. A Tuxedo application instance can be yet another resource of resource type “Tuxedo application server”. In addition, each cluster computer, IP address, or disk can also be identified as a resource belonging to its corresponding resource type.

Cluster Server Architecture

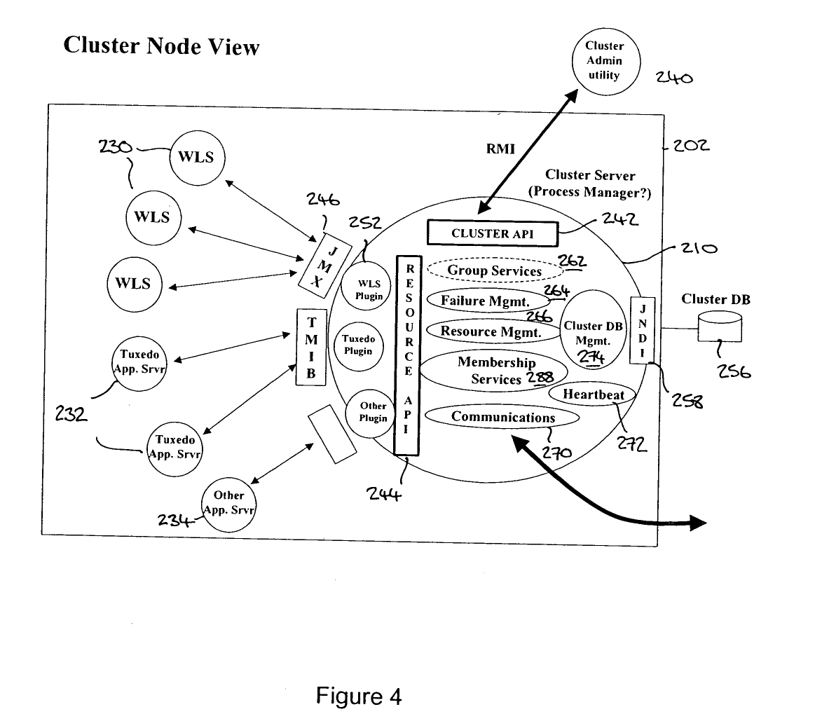

FIG. 4 illustrates in further detail the architecture of a cluster server in accordance with an embodiment of the invention, and its relationship to the application it manages. The cluster server architecture is used to provide the foundation for the high availability framework, and provides the following core functionality:

Cluster-wide synchronization and coordination services;

Cluster membership changes; and,

Detection of node failure.

As shown in FIG. 4, the particular computer or machine 202 which incorporates the cluster server 210 includes a variety of resources and interfaces, including a cluster application program interface (API) 242, group services 262, failure management 264, resource management 266, membership services 268, communications 270, a heartbeat interface 272, cluster database and management 274, a JNDI interface 258, and a resource API interface 244. The JNDI interface 258 provides an interface between the cluster server and a cluster database 256. The heartbeat interface 272 provides heartbeat information to other cluster servers. The cluster API interface 242 is provided to allow a cluster administration utility 240, or another client, to access and administer the cluster server using remote method invocation (RMI) calls. The resource API 244 allows the cluster server to talk to a variety of plug-ins, which in turn interface with other application servers and support a high availability framework for (or which includes) those servers.

For example, as shown in FIG. 4, the resource API may include a WLS plug-in 252 which interfaces with a JMX interface 246 to provide access to a plurality of WLS server instances 230. Similarly, a Tuxedo plugin can be used to provide access to a variety of Tuxedo application server instances 232. Additional third party plug-ins can be used to provide access to other application server instances 234.

### Cluster Updating

Embodiments of the Cluster Server architecture described above provide for Cluster-wide synchronization and coordination of services through a cluster update mechanism such as the Global Update Protocol (GLUP). Other cluster update mechanisms could be used to provide a similar functionality. GLUP uses a distributed lock (global lock), together with sequence numbers, to serialize the propagation of global events across the active members of the cluster. Events such as Cluster membership changes, resource related events (e.g. create, delete, attribute set) make up the greater set of global events. Every global update has a unique sequence number (across the cluster) associated with it. This sequence number may be considered the identifier or the id of the particular global update within the cluster. GLUP thus ensures that every active member of the cluster sees the same ordering of the global events.

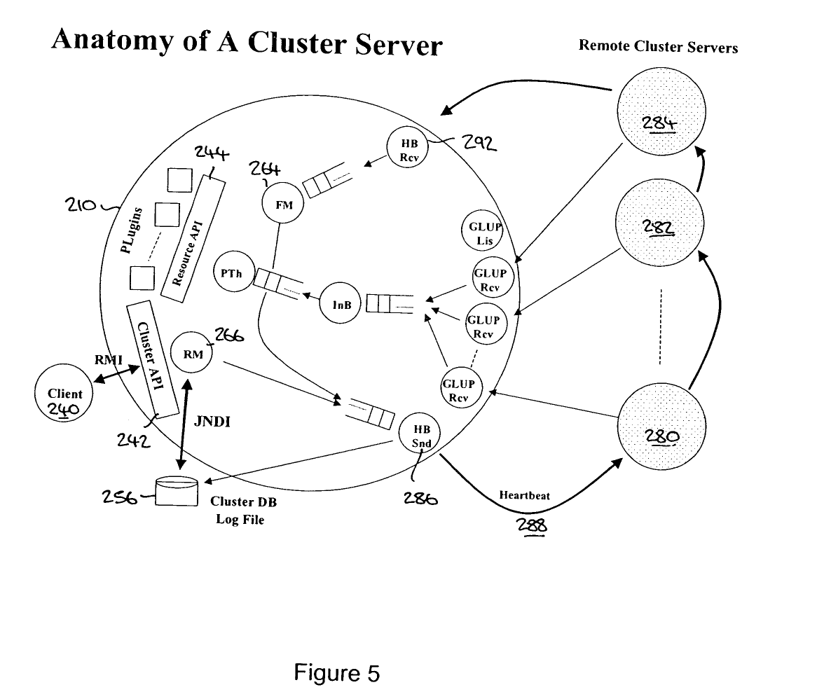

FIG. 5 illustrates how a plurality of cluster servers and GLUP can be used to provide support for a high availability framework. As shown in FIG. 5, a cluster server participating in the high availability framework communicates availability information to other cluster servers 280, 282, 284, using heartbeat information 288. In addition to the resource API 244 and cluster API information 242 described above, the cluster server includes mechanisms for sending and receiving heartbeat information to insure high availability. As shown in FIG. 5, this heartbeat information can be sent by a heartbeat sender mechanism 286 to each other cluster server in the enterprise environment. The resulting heartbeat is received at a heartbeat receiver 292 at each member of the cluster. Global framework information, such as that provided by GLUP, is used to augment the heartbeat information and to provide a reliable indication of the overall framework availability. This information can then be written to the cluster database log file 256, for subsequent use in the case of a failover or failure of one of the cluster members.

Node Failure Detection

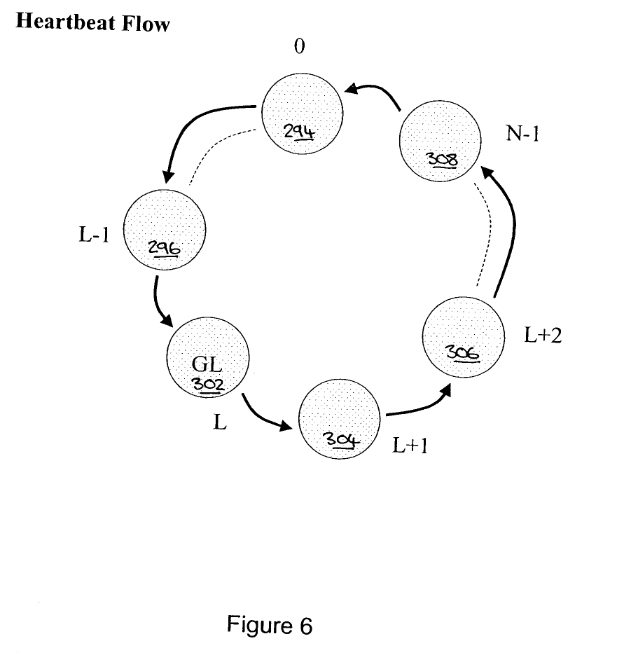

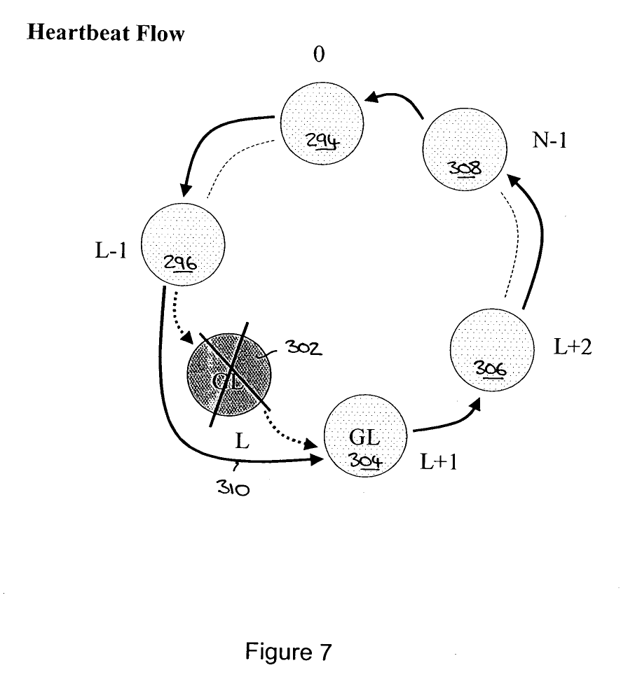

In accordance with one embodiment, the Cluster Server is also responsible for detecting node failure and subsequently triggering the cluster reformation and the follow-up of any other relevant operations. In accordance with one embodiment, cluster members periodically send a heartbeat to their neighboring nodes in accordance with a daisy-chain topology. FIGS. 6 and 7 illustrate the flow of heartbeat information as it passes from one cluster server to another cluster server in accordance with this type of topology. As shown in FIG. 6, as heartbeat information is passed between a group of cluster servers, information is passed along a chain from each cluster server, in this example from cluster server 294, to all other cluster servers within the framework, for example cluster servers 296, 302, 304, 306, and 308. As long as all of the heartbeats are received from each succeeding cluster server, then the system knows that there is currently no failure or failover present.

FIG. 7 illustrates the mechanism by which a heartbeat failure is used to detect the failure or failover of one of the cluster servers. As shown in FIG. 7, cluster server 302, which was formerly the group leader, has now been removed from the loop, i.e., it has failed or is in a failover condition. When the failure in heartbeat is detected, the next cluster server in the group, in this example server 304, assumes the role of group leader, and initiates a new heartbeat sequence. The process can be summarized as follows: The group leader initiates the heartbeat sequence. Each cluster server passes this heartbeat information along the chain to other machines (and servers) within the group. If a failure occurs the system recognizes the failure in the heartbeat communication and removes the failed server/machine from the loop. If the failed machine was the group leader then a new group leader is selected, typically being the server that immediately follows the old group leader in the sequential heartbeat chain.

The communications layer establishes and maintains all of the peer-to-peer socket connections, implements GLUP and provides the basic GLUP service, in addition to providing a point-to-point, Tuxedo-like conversational style service to other components of the Cluster Server. The latter service is used in one embodiment during the synchronization (synching) of a joining member of the cluster with the rest of the cluster.

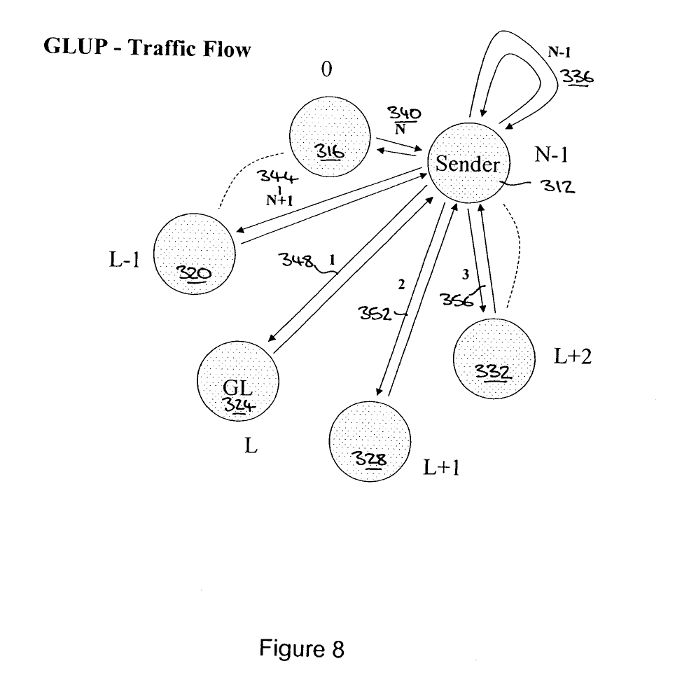

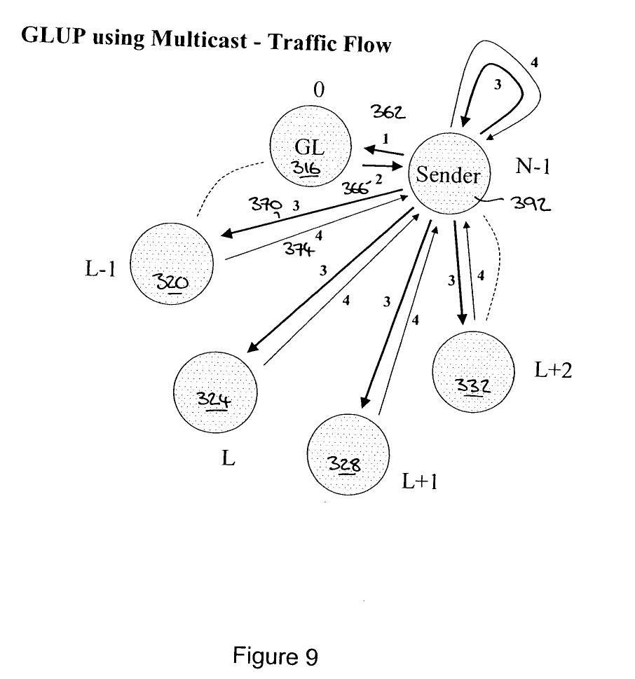

FIGS. 8 and 9 shows a multicast process in accordance with an embodiment of the invention. The sender-receiver communication is typically serialized, i.e., one-at-a-time, with one-after-another. However, scalability of the protocol can be improved by utilizing multicasting where applicable. FIG. 8 illustrates how in accordance with one embodiment of the invention the heartbeat information is passed between cluster servers in a parallel rather than in a serial manner. As shown in FIG. 8, the sending cluster server (sender) 312 initiates a sequence of multi-cast heartbeats, including a heartbeat 336 sent to itself, and heartbeats 340, 344, 348, 352, and 356 that are sent to other cluster servers within the framework. The sender 312 sends heartbeats to each cluster server in turn, and waits for the corresponding response from each heartbeat signal. FIG. 9 illustrates an alternate embodiment of the heartbeat sending mechanism wherein the heartbeat is sent using a multicast pattern so that the heartbeat can be sent to any or all of the cluster servers at the same time, and in which case the sender waits for all of the heartbeats to return before proceeding. This mechanism provides for greater scalability than the non-multicast method.

### Cluster API

The Resource Manager is responsible for managing information about resources and invoking the Resource API methods of the plug-ins. The plug-ins implement resource-specific methods to directly manage the resource instances. In addition, the Resource Manager component implements the Cluster API. In one embodiment, the Cluster API is a remote interface (RMI) that allows administrative clients to perform various functions, including the following functions:

Create Resource Types

Create Resource Groups

Create/delete/modify resources

Get/Set attributes of a resource

Move a Group

The same Cluster API is used for updating the view of the local Cluster database (DB) during a GLUP operation. Cluster clients, including any utility for administration, can use this interface to talk to the cluster. HAFW maintains all of the cluster-wide configuration/management information in the Cluster DB. The Cluster DB, which can be implemented as a JNDI tree, uses the file system as the persistent store. This persistent store is then replicated across the members of the cluster. A current serialized version of each resource object is maintained within the file system. When a resource's internal representation is changed, as the result of a GLUP operation or an administrative command, the current serialized version of the object is also updated.

One member of the cluster is designated to be a group leader until it becomes inactive for some reason, usually due to a failure a failover. When the group leader becomes inactive, another active member takes over the responsibility. The group leader maintains the GLUP lock and is therefore always the first receiver of a GLUP request from a sending node. A positive acknowledgment of a GLUP request by the group leader implies that the global update is committed. It is then the sender's responsibility to handshake with the rest of the cluster members, including itself.

A timeout mechanism can be included with the cluster server to break deadlock situations and recover gracefully. For example, if a GLUP request is committed, but then the request times out on the group leader, the group leader can resubmit the request on behalf of the sender (the member which originally requested the GLUP operation). The group leader also logs a copy of the global update request into a log file on a shared resource. Logging the record thus becomes a part of the commit operation.

The log file is typically of a fixed size (although its size is configurable by an administrator), and comprises fixed size records. In most embodiments, entries are written in a circular buffer fashion and when the log file is full, the Cluster DB is checkpointed, i.e., a snapshot of the Cluster DB is written to persistent store. A header of the log file, containing data such as cluster name, time of creation, and the sequence number of the last log record written into the log is also included. This file is important for synchronizing a joining, or an out of sync member with the cluster.

### Resource API

In accordance with one embodiment, the Resource Application Program Interface (API) is an interface used within the Cluster Server that is implemented by a plug-in. Each plug-in is specific to a resource type, and all resources of that type use the same plugin methods. A plug-in is loaded at the time the first resource of a defined type is created. The “open” method of the plug-in is then called when the resource is created and this method returns a handle to the specific resource instance. This handle is then used in subsequent method calls.

In one embodiment the Resource API interface comprises the following methods although it will be evident that additional or alternate methods may be provided:

RscHandle Open(String rscName,
Properties properties,
SetRscStateCallback setState,
LogEventCallback logEventCallback)
int Close(RscHandle handle)
int Online(RscHandle handle)
int Offline(RscHandle handle)
int Terminate(RscHandle handle)
int IsAlive(RscHandle handle)
int IsAliveAsynch(RscHandle handle, IsAliveCallback isAliveCallback)
int SetProperties(RscHandle handle, Properties properties)
Properties GetProperties (RscHandle handle) ;

The plug-in methods can be designed to execute in the same JVM as the Cluster Server. However, it is often more desirable in a high availability framework that the functioning of the Cluster Server not be affected by programmatic errors of a plug-in. Therefore, the Resource API may also be implemented as a remote interface to the plug-in implementation.

The plugins implementing the Resource API encapsulate the resource type-specific behavior, and isolate the Cluster Server from that behavior. The plugins provide the mapping between HAFW's resource management abstractions and the resource type-specific way of realizing the particular functionality. For example, in the case of a WLSApplication resource type, the corresponding plug-in utilizes WLS's JMX interface to realize the Resource API. In the case of a Tuxedo application, the corresponding plug-in may utilize Tuxedo's TMIB interface. Other resource types, including third-party resource types may utilize their corresponding interface.

Cluster Join

A cluster member may join an active cluster by executing the following command:

java ClusterServer
[-c <Cluster Name>]
[-g <IP address>:<PortId>]
[-l <IP address>:<PortId>]
[-q <Quorum File>]
[<Configuration File>]

All the options of ClusterServer have default values, so for example in the above command the various options take the following meanings and default values.

The -c option allows a cluster name to be specified.

The -g option is used to specify group leader.

The -I option provides a manual control over determining how to get to the group leader in those cases in which the shared resource containing the quorum file is not available to the joiner. The associated argument specifies the listening address of either the group leader or another active member of the cluster. If the address of a non-group leader member is specified, then the initial communications with that member will supply all the necessary information to the joiner to connect to the group leader.

The q or <Quorum File> option contains the current group leader specifics, an incrementing heartbeat counter (updated periodically by the current group leader), and in some instances additional data.

The <Configuration File>, when specified, contains cluster-wide and member specific configuration data, e.g. the cluster name, heartbeat intervals, log file, quorum file, and the name and listening addresses of cluster members. It is only used by a member that is forming the cluster for the first time (first joiner), as all the subsequent joiners receive this cluster configuration information directly from the group leader during the joining process.

Authentication

In one embodiment the HAFW uses a built-in password to authenticate the joining members. This happens during the initial join operation when a member joins the cluster. A message containing the expected password is the first message sent by the joining member. If this password cannot be verified and/or the joiner is not known to the cluster, then the join request is rejected. It will be evident that more sophisticated security mechanisms can also be used, including ones based on digital signature technology.

Move Operation

The “Move” operation (move) is an important operation provided by the framework. A move may be one of many flavors, including for example a planned move or an unplanned move (otherwise referred to as a failover). The target object of a move operation is a resource group, and the operation results in moving the specified resource group from one node (i.e., the current host) to another node (i.e., a backup node) within the cluster. The move is realized by placing off-line (off-lining) all of the active resources in the specified resource group on the current host first, and then bringing them back on-line (on-lining them) on the backup host. Finally, the current host attribute is set to that of the backup host. This is similar to a multi-phase GLUP operation with barrier synchronization.

A planned move is usually one that is triggered by the user (i.e., the administrator). For example, one may need to apply regular maintenance to a production machine without disrupting the overall production environment. So, in this case the load must be moved from the maintenance machine to another one, the machine serviced, and finally the load moved back (failback) to its original node. Conversely from the planned move, an unplanned move is triggered as a result of dependent resource failures, for example, as a result of a node failure.

Database Structure and the Log Database

In accordance with one embodiment of the invention each node within the high availability framework (HAFW) retains a copy of the framework database which it uses to track current availability information, for use in those instances in which a failover is detected. Typically, the group leader is the only cluster server or framework member who reads or writes data to the log file on the database. In any instance in which the group leader fails, the log file must be on a shared resource so that the new group leader can access it. The framework quorum file must also be stored on a shared resource in case of a group leader failure.

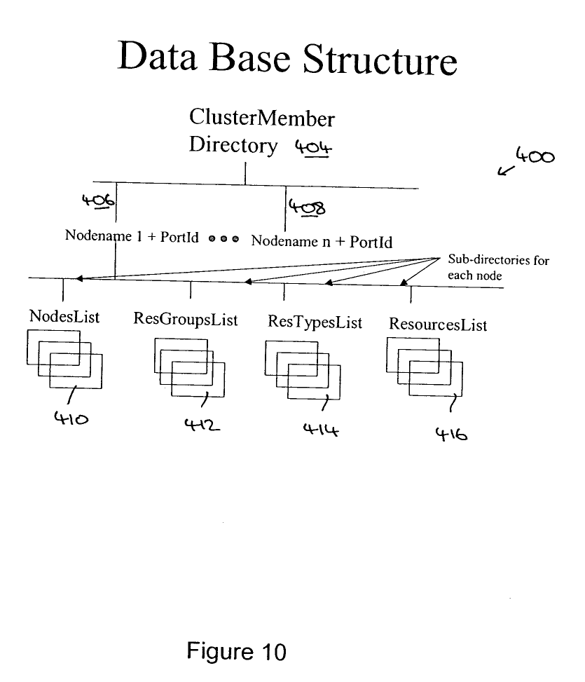

FIG. 10 illustrates how the various resource objects are stored within the framework database in accordance with an embodiment of the invention. As shown in FIG. 10, the database structure 400 includes a cluster member directory 404, which in turn includes entries for each node name, including in this example node name “1” 406 and node name “n” 408. A set of sub-directories are included for each node, which in turn include entries for node lists 410, resource group lists 412, resource type lists 414, and resource lists 416. The information in the database is used to provide resources to the client in a uniform manner, so that any failure within the framework can be easily remedied.

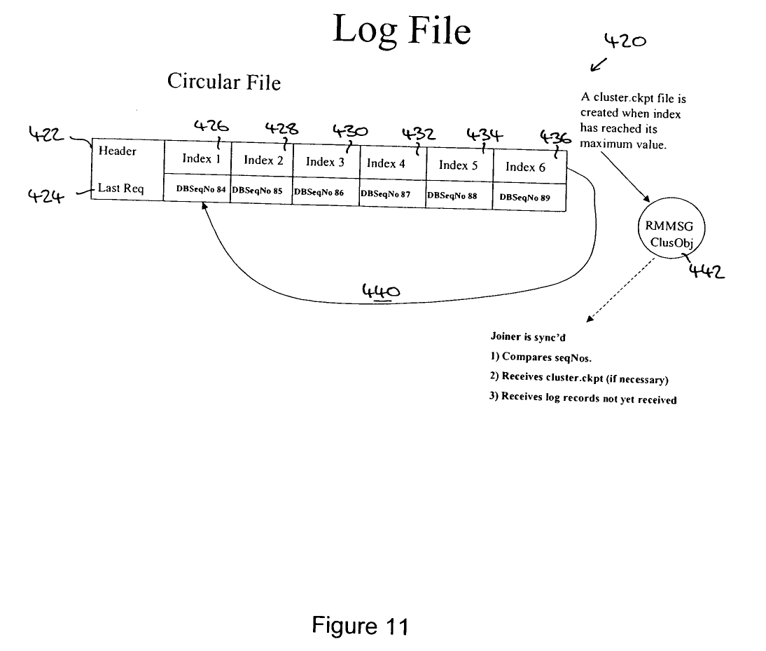

FIG. 11 illustrates one implementation of the log file as it is used in the high availability framework. The log file contains a plurality of recorded entries and is typically recorded in a circular manner, so that for example the last index in the log file links back 440 to the first index. Typically the log file includes header information 422, and last request information 424, for each of the plurality of entries including in this example, 426, 428, 430, 432, 434, and 436. The log file is maintained by the current group leader and contains all of the important information that has happened in the recent past that may at some point be needed to recover from a failover or failure. A cluster check point file is created whenever the index reaches a maximum value.

Client RMI Access

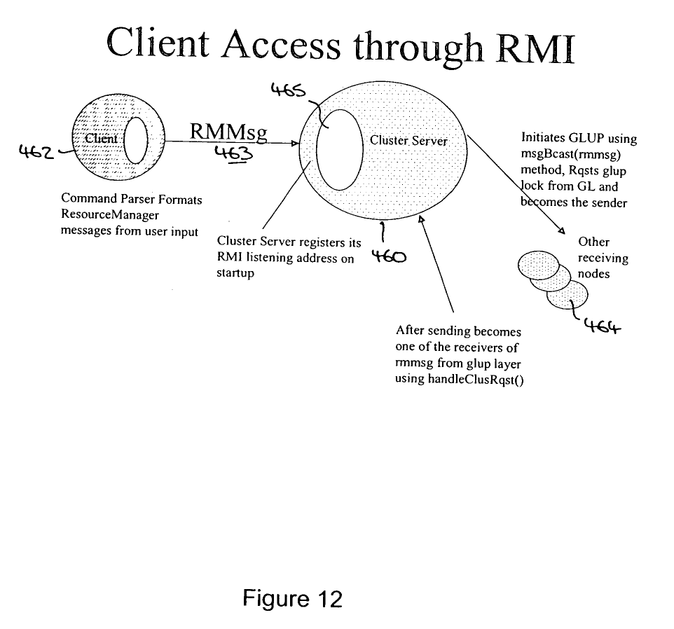

FIG. 12 illustrates how in accordance with one embodiment of the invention, a client application can use an invocation method such as Remote Method Invocation (RMI) to access a cluster server for administration or other control purposes. As shown in FIG. 12, the client or client application 462 accesses the cluster server 460 using an RMI message 463. The cluster server registers its RMI listening address 465 upon start up. Upon receipt of the message from the client, the cluster server initiates GLUP using a broadcast method, and requests a GLUP lock from the current group leader. The cluster server then becomes the sender. This information is passed along to all other receiving nodes 464. Once the message is forwarded to the other receiving nodes, and following the completion of the sending process, the cluster server then becomes one of the receivers of the message from the GLUP layer.

The Resource API may or may not be RMI based. If it is not RMI-based then the plug-ins are loaded into the address space of the Cluster Server. This potentially compromises the reliability of Cluster Server. An RMI based API allows the plug-ins to be loaded in separate processes, in addition to providing the following features:

Restructuring of the implementation in-line with logical components.

Support for replicated resource groups and resources.

Improved error recovery and robustness in general.

Support for network redundancy.

High Availability Framework

The system described above can be incorporated into a wide variety of application server environments to provide high availability in those environments. Particularly, some embodiments of the invention can be used with or incorporated into an enterprise application server, such as the WebLogic Server product from BEA Systems, Inc., to provide clustering in that environment. This approach offers HAFW as a complementary product to the traditional application server Clustering.

One question that may arise is who should provide the plug-ins for the various resource types. For other than the native (i.e., in the case of WebLogic then the native WLS and Tuxedo) applications, the actual application owners or software developers are the most likely candidates. For critical resource types such as Oracle DB servers, disks, etc., the resource provider or third party source may provide the plug-in.

Another aspect of this issue is that the use of the HAFW system means that the application system vendor need not provide all of the plug-ins for all of the foreseeable resource types. Some key resource types are sufficient to begin with, while additional plug-ins can be added later, on an as-needed basis.

An alternate approach is to allow existing application servers such as WebLogic Server (WLS) to be modified so that they embed HAFW functionality. Regardless of the approach taken, HAFW functionality can be provided by the application server environment in many different ways, which in turn provides numerous benefits. These benefits include:

Enable the application server to address HA in proper context.

Provide an extensible and uniform HA and application/system management framework.

Enhance scalability of application services such as WLS.

Potentially reduce memory foot print of the application server and therefore squeeze more WLS instances into a given machine with potentially better performance.

Provide a stable and reliable infrastructure platform of e-commerce.

Cluster/LAN Architecture

In accordance with one embodiment of the invention, a system architecture can be provided in which a server instance (for example a WLS instance) in every cluster acts as an application management agent for that cluster and as a bridge between the Administration Server and the members (for example, the other WLS instances) of the cluster. It is also the responsibility of this agent to propagate the incoming data from the Administraton Server to the members, and to ensure cluster level aggregation of data. Although this architecture improves the scalability relative to traditional architectures from the perspective of application management, it does pose some potential scalability problem as a consequence of excessive (redundant) network traffic, particularly in topologies in which multiple clusters share a group (i.e., size greater than 1) of physical nodes. If a cluster has more than one instance hosted on the same remote node relative to the cluster member acting as the application agent for the cluster, then redundant network traffic starts to occur. This problem will get worse with greater number of clusters.

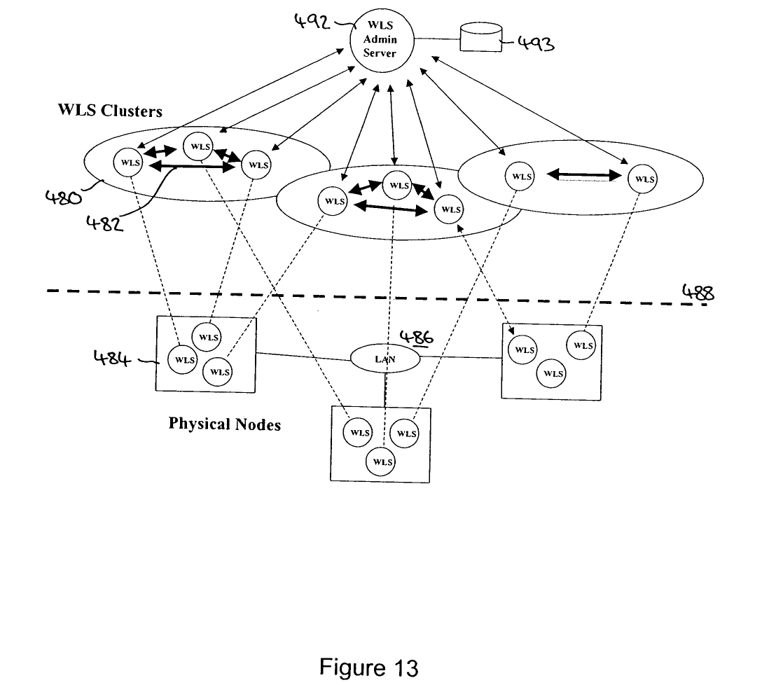

FIG. 13 illustrates an embodiment of the invention as it can be used to provide an application management architecture in a WebLogic server or similar application server environment. A set of physical machine nodes 484 connected by a LAN 486 make up the physical server environment. In accordance with this implementation, the WLS clusters are comprised of WebLogic server instances 480. One of these instances is configured to act as a WLS administration server 492, that can be used to manage the clusters and cluster members. Information about the cluster is stored in a cluster database 493.

Alternative Cluster/LAN Architecture

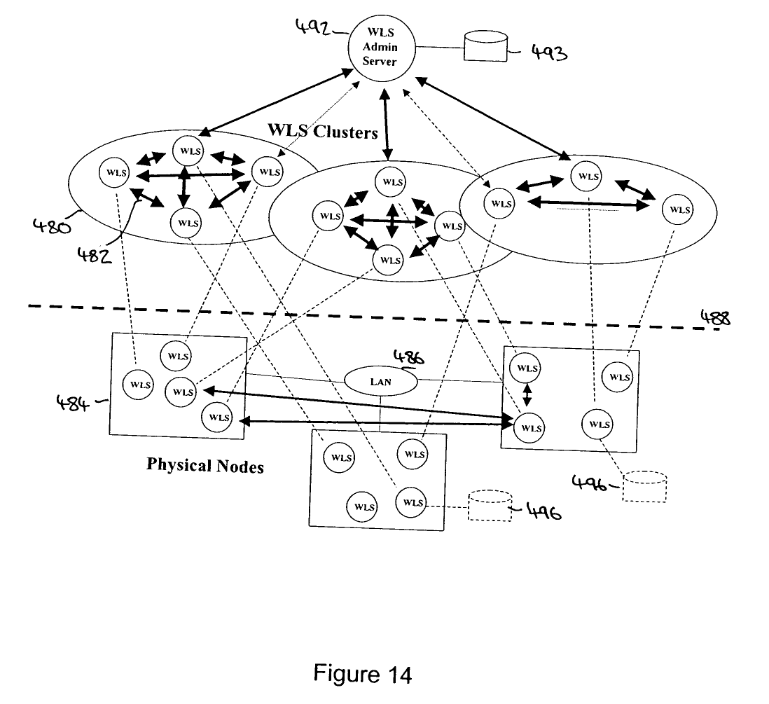

FIG. 14 illustrates an alternate embodiment of the invention in which one server instance (such as a WebLogic server instance) in each server cluster acts as an application management agent for that cluster, and also as a bridge between the WLS administration server and the members i.e. the WLS instances of the cluster. The physical nodes include a copy of the cluster database 496.

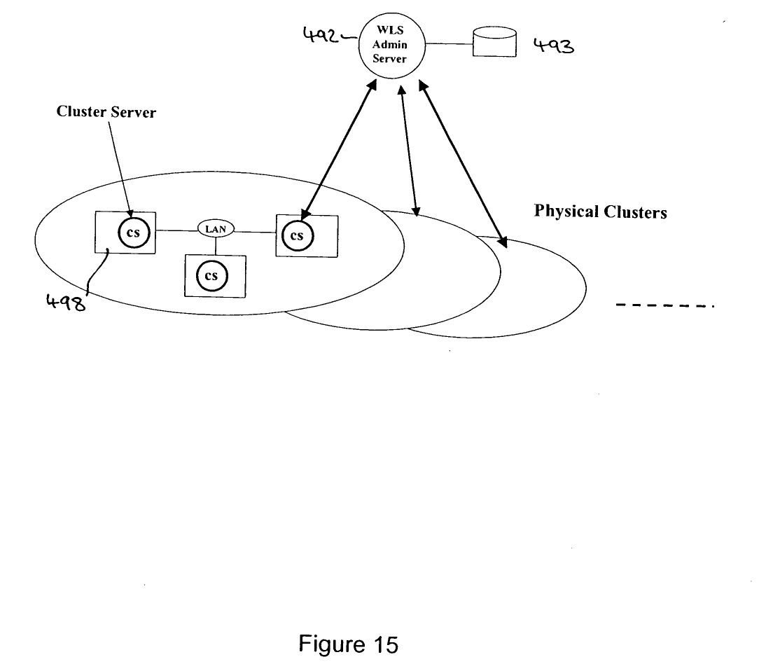

FIG. 15 illustrates a cluster view from the physical computer level, in which a group of interconnected computers each supporting a Java virtual machine are represented. Each physical machine includes a cluster server 498.

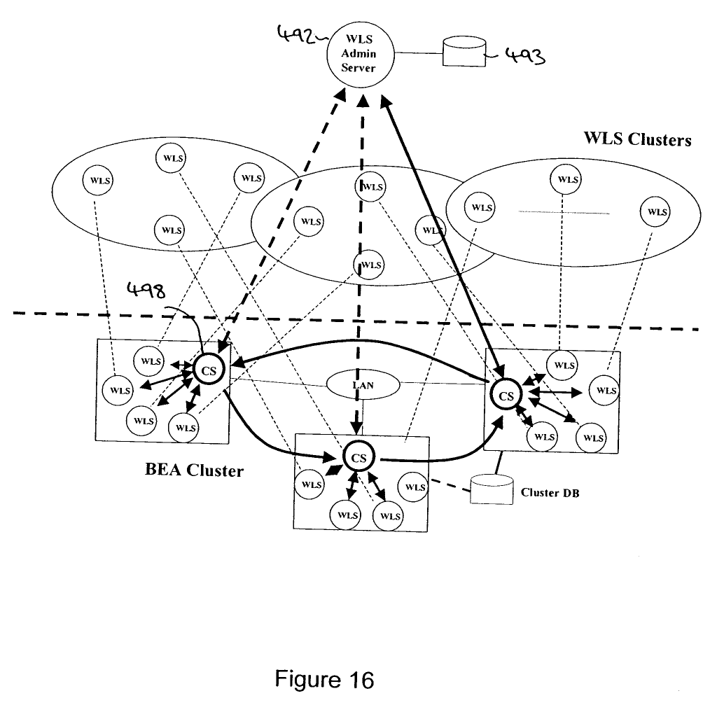

FIG. 16 illustrates an alternate implantation of the high availability framework based upon the physical implementation shown in FIG. 15.

In accordance with the invention, a cluster may be viewed at the physical level as a group of interconnected computers, each supporting a Java Virtual machine. The domain becomes the unit of administration, consisting of n number of clusters where n>=1. Given a particular cluster, each active member hosts a process named Cluster Server. Cluster Servers within a cluster coordinate and synchronize the global events across the cluster by propagating and registering them in an orderly and reliable fashion. They are also responsible for physical node and network level monitoring for liveness (heartbeat). Each Cluster Server, in addition to being an application management agent for the entities hosted on the same host, also provides the framework for loading the application type specific monitoring plugins (implementations of Resource API). Cluster clients (e.g., a cluster administration utility) interact with the cluster through a Cluster Admin API. Cluster Server also implements the Cluster Admin API. Cluster Server API can be supported through Java JMX and the corresponding Mbeans.

Cluster Server Layered Architecture

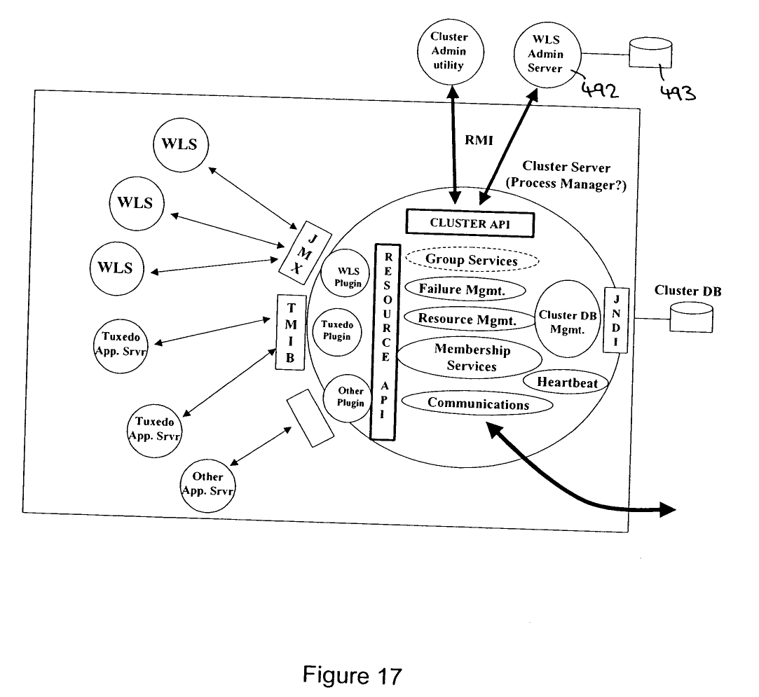

FIG. 17 depicts the anatomy of a Cluster Server process in accordance with one embodiment of the invention, in which the Cluster Server has a layered architecture. The communications layer provides core communications services; e.g. multicasting services with varying consistency/scalability characteristics. The membership layer is responsible for consistent view of the cluster membership across the cluster. The managed objects of this environment are referred to as resources. The Resource Manager together with the Cluster Database is responsible for managing the resources in the cluster. The Group Services layer supports a simple Group Services API (that can be an extension to Cluster Admin API) for forming/joining/leaving/subscribing to a group. A group of WLS instances can be grouped together and create a WLS cluster. This is also true for any application. Cluster Servers manage these process groups. The admin console (or Management Console) 492 is essentially the client of the clusters it oversees. It communicates with the clusters in the domain through the Cluster Admin API. The Cluster DB 493 can either be replicated across the cluster members or be a singleton on a shared persistent store. To eliminate the potential single point of failure situation, the Cluster Servers can use cluster buddies to monitor, restart, or take over when necessary.

Use of Process Groups Within the Framework

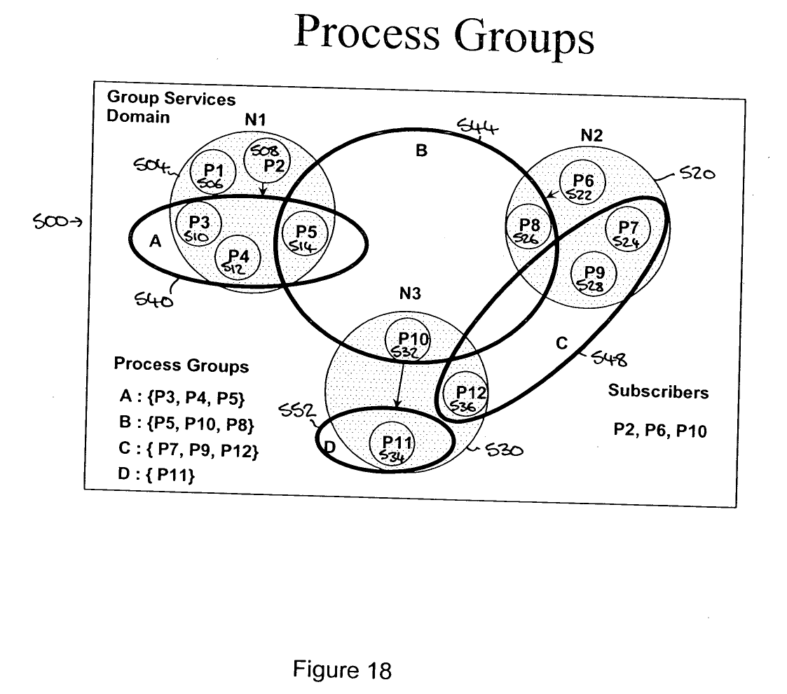

FIG. 18 illustrates a mechanism by which, in utilizing the framework described herein, individual framework subscribers can be grouped together to provide process groups. As shown in the example in FIG. 18, within a group services domain 500, there may be a number or plurality of cluster members including member N1 504, member N2 520, and N3 530. Each of these members include a number or plurality of processes or servers executing thereon, including for example P1, P2, P3, P4, and P5 (506, 508, 510, 512, and 514 respectively) on member N1, and soon. In the cluster environment provided by the invention some or all of the services or resources from individual cluster members can be grouped together to form process groups. For example, a process group A 540 can be formed from the processes P3, P4, and P5 all of which are on member N1. A process group B 544 can be formed from process P5 on member N1, P8 on member N2, and P10 on member N3. Other process groups can be similarly created. In this way the framework provided by the invention can be used to present to the client a uniform set of processes or services that in turn execute on different cluster members.

In summary, the invention described herein can be summarized as follows: It provides a uniform, flexible and extensible high availability and application/system management architecture; It localizes what needs to be localized, e.g. application and physical level monitoring; It minimizes redundancy (as a result of consolidation), e.g. excessive network and disk I/O traffic due to heartbeats, synchronization, coordination and global updates; and, It potentially minimizes the memory footprint of the application server proper by consolidating clustering related core functionality inside Cluster Servers.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to capturing and annotating media streams, producing a timeline of significant note-taking events, linking still frames to points in or segments of a media stream, recognize any slide changes, production and distribution of meta data describing at least a part of a media stream, and communication of results according to the processes of the present invention.

As used herein, a given signal, event or value is “responsive” or “in response to” a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same as the predecessor signal, event or value, this is merely a degenerate case in which the given signal, event or value is still considered to be “responsive” to the predecessor signal, event or value. “Dependency” of a given signal, event or value upon another signal, event or value is defined similarly. The present invention may be conveniently implemented using a conventional general purpose or a specialized digital computer or microprocessor programmed according to the teachings of the present disclosure, as will be apparent to those skilled in the computer art.

The foregoing description of the present invention has been provided for the purposes of illustration and description. It is not intended to be exhaustive or to limit the invention to the precise forms disclosed. Particularly, while embodiments of the invention have been described with regard to use in a WebLogic environment, other types of application server and other environments could be used. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for high availability clustering, comprising:
a computer that allows a user or application to access a set of resources of various resource types, said resources available at said computer or at another computer;
a cluster server that operates at said computer and that allows access to said set of resources;
a resource interface provided by said cluster server and that allows the cluster server to communicate with said set of resources via a plurality of plugins into said resource interface, wherein each resource type is associated with a particular plugin, and wherein each resource of a particular type at said computer communicates with the cluster server via the particular plugin associated with that resource type;
wherein additional plugins may be included in the resource interface for other resource types; and,
wherein the system can be extended by adding additional computers with cluster servers and resource interfaces operating thereon.

2. The system of claim 1 wherein each of said cluster servers includes a heartbeat interface that provides heartbeat information to other cluster servers at said other application servers.

3. The system of claim 1 wherein the system is Java-based.

4. The system of claim 3 wherein the system includes a JNDI interface that provides an interface between the cluster server and a JNDI-compliant database.

5. The system of claim 1 wherein the system includes a cluster administration utility for accessing and administering the cluster server using remote method invocation calls.

6. The system of claim 1 wherein each resource has a resource type associated with it.

7. The system of claim 6 wherein resources are the object instances of their respective resource types..

8. The system of claim 1 wherein a resource is any of a computer, internet protocol address, disk, database, or file system or application.

9. The system of claim 1 wherein the cluster server defines resource groups that includes clusters of resources.

10. The system of claim 1 wherein the plugins include a WebLogic plugin.

11. The system of claim 1 wherein the plugins include a Tuxedo plugin.

12. A method for providing a high availability clustering framework system, comprising the steps of:
allowing a user or application to access, via a computer and a cluster server operating thereon, a set of resources of various resource types, said resources being available at said computer or at another computer;
providing a resource interface at said cluster server that allows the cluster server to communicate with said set of resources via a plurality of plugins into said resource interface, wherein each type of resource within said set of resources is associated with a particular plugin, and wherein each resource of a particular type communicates with the cluster server via the particular plugin associated with that resource type;
wherein additional plugins may be included in the resource interface for other resource types; and,
wherein the system can be extended by adding additional computers with cluster servers and resource interfaces operating thereon.

13. The method of claim 12 wherein said cluster server includes a heartbeat interface provides heartbeat information to other cluster servers at said other application servers.

14. The method of claim 12 wherein the system is Java-based.

15. The method of claim 14 wherein the system includes a JNDI interface that provides an interface between the cluster server and a JNDI-compliant database.

16. The method of claim 12 wherein the system includes a cluster administration utility for accessing and administering the cluster server using remote method invocation calls.

17. The method of claim 12 wherein each resources has a resource type associated with it.

18. The method of claim 17 wherein resources are the object instances of their respective resource types.

19. The method of claim 12 wherein a resource is any of a computer, ip address, disk, database, or file system or application.

20. The method of claim 12 wherein the cluster server allows for clustering resources within a resource group.

21. The method of claim 12 wherein the plugins include a WebLogic plugin.

22. The method of claim 12 wherein the plugins include a Tuxedo plugin.

23. A system for providing resource groups in a cluster comprising:
a cluster server that provides access to resources at an application server, wherein said application server includes a plurality of resources and wherein each of said resources has a resource type associated with it;
a plurality of resource groups accessible via said cluster server, each of which resources group includes a number of associated resources; and,
a resource interface which allows the cluster server to talk to a plurality of plugins, wherein said plugins interface with a plurality of application servers to support a high availability framework between the cluster server and said application servers.

24. A method for providing resource groups in a cluster comprising:
accessing a cluster server which includes a plurality of resources accessible thereupon wherein each of said resources has a resource type associated with it;
defining a plurality of resource groups accessible via said cluster server, each of which resources group includes a number of associated resources; and,
using a resource interface to communicate with a plurality of plugins, which plugins in turn interface with a plurality of other application servers to support a high availability framework between the cluster server and said other application servers.

25. A system for high availability clustering, comprising:
a plurality of computers that allow a user or application to access a set of application servers or application server instances, said application servers being of various types and operating on said plurality of computers;
a cluster server that operates on each of said computers and that allows access to the set of application servers on that computer;
a resource interface provided by said cluster server on each computer that allows the cluster server to communicate with the set of application servers on that computer via a plurality of plugins into said resource interface, wherein each type of application server is associated with a particular plugin, and wherein each application server of a particular type communicates with the cluster server via the particular plugin associated with that application server type; and,
wherein additional plugins may be included in the resource interface for other application server types.

26. A method for high availability clustering, comprising:
a plurality of computers that allow a user or application to access a set of application servers or application server instances, said application servers being of various types and operating on said plurality of computers;
a cluster server that operates on each of said computers and that allows access to the set of application servers on that computer;
a resource interface provided by said cluster server on each computer that allows the cluster server to communicate with the set of application servers on that computer via a plurality of plugins into said resource interface, wherein each type of application server is associated with a particular plugin, and wherein each application server of a particular type communicates with the cluster server via the particular plugin associated with that application server type; and,
wherein additional plugins may be included in the resource interface for other application server types.
